(19) United States
(12) Patent Application Publication
(10) Pub. No.: US 2003/0039580 A1
(43) Pub. Date: Feb. 27, 2003

(54) Stable preservative formulations comprising halopropynyl compounds and butoxydiglycol solvent

(75) Inventors: Olga Borokhov, Chatham, NJ (US); Patrick Jay Lutz, Nazareth, PA (US); John G. Maroski, Bethlehem, PA (US)

Correspondence Address: DARBY & DARBY P.C., 805 Third Avenue, New York, NY, 10022, US

(73) Assignee: Lonza Inc., Fair Lawn, NJ (US)

(21) Appl. No.: 10/085,496

(22) Filed: Feb. 26, 2002

Related U.S. Application Data
(60) Provisional application No. 60/271,760, filed on Feb. 26, 2001.

(51) Int. Cl. A01N 1/00

(52) U.S. Cl. 422/37

(57) ABSTRACT

Disclosed are stable, liquid broad spectrum preservative formulations comprising (a) an antimicrobial halopropynyl compound and (b) a butoxydiglycol solvent, and optionally (c) (i) an alkanol substituted dialkylhdantoin formaldehyde donor, (ii) an antimicrobial isothiazolone derivative, and (iii) a stabilizer. The invention is also directed to methods of use of the preservative formulations for inhibiting or retarding the growth of bacteria or fungi.

This application claims priority under 35 U.S.C. §119(e) of provisional application serial No. 60/271,760, filed Feb. 26, 2001, which is hereby incorporated by reference.

### FIELD OF THE INVENTION

This invention relates to stable, liquid preservative formulations comprising (a) a halopropynl compound and (b) a butoxydiglycol solvent, and optionally (c) (i) an alkanol substituted dialkylhdantoin formaldehyde donor, (ii) an isothiazolone derivative, and (iii) a stabilizer. The invention is also directed to methods of using the preservative formulations for inhibiting or retarding the growth of microbes, including bacteria and/or fungi.

### BACKGROUND OF THE INVENTION

The need for effective and economical preservative compositions is well known. Many products, including personal care products such as shampoos, creams, lotions, cosmetics, and soaps, household products such as laundry detergents, hard surface cleaners, fabric softeners, and various industrial products, require preservatives to protect against contamination and growth of bacteria or fungi. In particular, personal care product compositions are a nutrient-rich media which benefit from the incorporation of preservatives to control the growth of microorganisms and to prevent spoilage. Generally, the shelf life of these products depends on the resistance to microbial spoilage of components contained therein. It is therefore desirable to formulate a preservative which controls microbial contamination in personal care products, household products, and industrial products.

For the foregoing applications, the demand for stable, broad-spectrum preservatives has increased. For example, formaldehyde and isothiazolone derivatives have been shown to be highly effective biocidal preservatives. U.S. Pat. No. 3,987,184, to Foelsch discloses 1,3-dimethylol-5,5-dimethylhydantoin (DMDMH) as a useful formaldehyde donor compound for the preservation of personal care products, cosmetics, and household and industrial products. Combinations of formaldehyde donors and halopropynyl compounds (e.g., 3-iodo-2-propynylbutyl carbamate (IPBC)) have achieved considerable commercial success. Such synergistic combinations have been described in, e.g., U.S. Pat. No. 4,844,891.

However, governmental regulations currently demand products containing a relatively low amount of free formaldehyde. In the case of DMDMH, improved formulations and processing has resulted in compositions which contain very low amounts of free formaldehyde. (See U.S. Pat. No. 5,405,862.)

Isothiazolone is highly toxic and very unstable under most circumstances, such as when present in water or other reactive molecules. To make the compound stable, large amounts of cationic salts are added and the isothiazolone is diluted (usually to about 14% or less). While under these conditions, isothiazolone is stable at room temperature at low pH (from 1-4). During storage and manufacturing conditions the temperature and pH may increase, causing isothiazolone to become unstable.

While highly useful for controlling bacteria, fungi and other contaminating microbes in end-use products, the instability of isothiazolone under less than ideal conditions results in a marked loss of activity. Thus, it would be advantageous to provide a preservative system that contains isothiazolone which is stable at a broad range of temperature and pH.

Additionally, under very acidic pH conditions, some end-use products such as personal care products cannot be easily formulated with isothiazolone. At less acidic pH levels, comparatively greater amounts of isothiazolone are needed in a preservative formulation because there is some loss of activity. Preferably, a preservative system should be easy to formulate and have low levels of stable isothiazolone, so that it is nontoxic and non-irritating, but still provides biocidal activity. Stable isothiazolone formulations which are effective at less acidic pH levels have not heretofore been easily obtained.

Furthermore, effective broad spectrum preservative systems that contain formaldehyde donors with low free-formaldehyde and stable isothiazolone for use in applications at less acidic pH levels, free of cationic salts and which are non-toxic, are not readily available.

U.S. Pat. No. 6,121,302 describes highly stable, preservative formulations having broad spectrum biocidal activity, which can be prepared by admixing one or more isothiazolones with a formaldehyde donor, such as alkanol-substituted dimethylhydantoins, and a hydantoin as a stabilizer for isothiazolone.

In addition, stable liquid preservative formulations having broad spectrum antimicrobial properties can be prepared by mixing alkanol-substituted dimethylhydantoins and antimicrobial halopropynyl compounds. For example, U.S. Pat. No. 6,143,204 describes preservative formulations comprising an alkanol-substituted dimethylhydantoin, an iodopropynyl compound, a stabilizer comprising hydantoin or urea or derivatives thereof, and a hydroxyl solvent.

### SUMMARY OF THE INVENTION

Applicants have discovered that the combination of a halopropynyl compound and butoxydiglycol solvent results in an unexpected synergistic antimicrobial formulation demonstrating synergistic properties, i.e. the formulation demonstrates antimicrobial properties which are greater than the additive fungicidal properties of halopropynyl and butoxydiglycol used alone.

In one embodiment, the invention is directed to stable, broad spectrum liquid preservative formulations comprising a halopropynl compound and butoxydiglycol solvent. In preferred embodiments, the halopropynyl compound is an iodopropynyl.

In additional embodiments, the invention is directed to stable, broad spectrum liquid preservative formulations comprising, (a) a halopropynyl compound, (b) an alkanol substituted dialkylhydantoin formaldehyde donor, and (c) butoxydiglycol. In preferred embodiments, the alkanol substituted dialkylhydantoin is dimethylol dimethylhydantoin, and the halopropynyl compound is an iodopropynyl compound, for example a halopropynyl carbamate such as iodo-2-propynylbutyl carbamate.

In another embodiment, the invention is directed to stable, broad spectrum liquid preservative formulations comprising (a) a halopropynyl compound, (b) an isothiazolone derivative, (c) an alkanol substituted dialkylhydantoin formaldehyde donor, (d) a hydroxyl solvent, and optionally (e) a stabilizer. Preferred halopropynyl compounds are iodopropynyl; preferred isothiazolone derivatives are 5-chloro-2-methyl-4-isothiazolin-3-one and 2-methyl-4-isothiazolin-3-one; a preferred alkanol substituted dialkylhydantoin is dimethylol dimethylhydantoin; and a preferred solvent is butoxydiglycol.

In additional embodiments, the invention is directed to a personal care product, household product, or industrial product comprising an antimicrobial effective amount of one of the preservative formulations of the invention. A preferred personal care product is a protein shampoo. Preferred industrial products are pulp and paper products.

The invention is also directed to methods for killing or retarding the growth of microbes (such as bacteria and/or fungi) in a composition susceptible to growth, comprising adding to said composition an effective amount of a preservative formulation of the invention.

The invention is also directed to methods of making liquid preservative formulations, comprising dissolving a halopropynyl compound in butoxydiglycol solvent. Additional water-based additives can be added to the halopropynyl-butoxydiglycol solution.

### DETAILED DESCRIPTION OF THE INVENTION

Definitions

As used herein, the term “biocidal” means capable of killing microorganisms, including bacteria, yeast, algae and fungi.

As used herein, the term “antimicrobial” means capable of killing and/or inhibiting growth of microrganisms, including bacteria, yeast, algae and fungi.

As used herein, the terms “antifungal” or “fungicidal” are used interchangeably, and mean capable of killing and/or inhibiting the growth of fungi.

As used herein, the terms “antibacterial” or “bactericidal” are used interchangeably, and mean capable of killing and/or inhibiting the growth of bacteria.

As used herein, the term “hydroxyl solvent” means a solvent containing one or more hydroxyl groups, and includes mono-, di- and polyhydroxy alcohols. Preferred monohydroxy alcohols are C₁₋₇ alcohols; preferred dihydroxy alcohols are C₁₋₈ diols; preferred polyhydroxy alcohols are C₂₋₈ polyols.

As used herein, the term “alkyl” refers to a straight or branched hydrocarbon group having a single radical.

As used herein, the term “alkenyl” refers to a straight or branched hydrocarbon group that contains from a single radical, and has one or more double bonds between carbon atoms.

As used herein, the term “cycloalkyl” means a non-aromatic mono or multicyclic hydrocarbon ring system of from 3 to 12 carbon atoms having a single radical.

As used herein, the term “cycloalkenyl” means a non-aromatic mono or multicyclic hydrocarbon ring system of from 3 to 12 carbon atoms having a single radical and at least one carbon to carbon double bond.

As used herein, the term “alkoxy” refers to the group —O-alkyl, wherein the alkyl moiety is as defined above.

As used herein, the term “aryl” means an aromatic carbocyclic ring structure having from about five to about fifteen carbon atoms. An aryl group may be a fused or polycyclic ring system.

As used herein, the term “heterocyclyl” means a closed ring structure having from about five to about fifteen atoms in the ring, in which one or more of the atoms in the ring is an atom other than carbon, such as oxygen, nitrogen or sulfur. A heterocyclic group may be aromatic or non-aromatic, and may be a fused or polycyclic ring system.

Halopropynl Compounds

A first active component of the stabilized preservative system of the invention is a halopropynyl compound, a fungicidally active iodopropynyl derivative. Suitable halopropynyl compounds are within the general structure (I):

YC≡C—CH₂X (I)

wherein Y is a halogen, preferably iodine and X can be (1) oxygen which is part of an organic functional group; (2) nitrogen which is part of an organic functional group; (3) sulfur which is part of an organic functional group; or (4) carbon which is part of an organic functional group.

The functional group of which oxygen is a part is preferably an ether, an ester, or a carbamate group. The functional group of which nitrogen is a part is preferably an amine, an amide, or a carbamate group. The functional group of which sulfur is a part is preferably a thiol, a thione, a sulfone, or a sulfoxide group. The functional group of which carbon is a part is preferably an ester, a carbamate or an alkyl group.

Examples of compounds which may be used as the halopropynyl compound of this invention are especially the fungicidally active iodopropynyl derivatives. In this regard, please see U.S. Pat. Nos. 3,923,870, 4,259,350, 4,592,773, 4,616,004, 4,719,227, and 4,945,109, the disclosures of which are herein incorporated by reference. These iodopropynyl derivatives include compounds derived from propynyl or iodopropynyl alcohols such as esters, ethers, acetals, carbamates and carbonates and the iodopropynyl derivatives of pyrimidines, thiazolinones, tetrazoles, triazinones, sulfamides, benzothiazoles, ammonium salts, carboxamides, hydroxamates, and ureas. Preferred among these compounds is the halopropynyl carbamate, 3-iodo-2-propynyl butyl carbamate (IPBC).

Preferred halopropynyl compounds are included within the broadly useful class of compounds having the generic formulas such as II and III shown below:

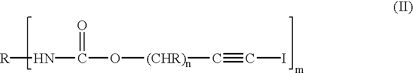

wherein:

R is selected from the group consisting of substituted and unsubstituted alkyl, aryl, and alkylaryl groups having from 1 to 20 carbon atoms; and

m and n are independent integers from 1 to 3; and

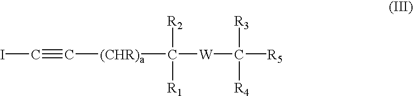

wherein:

R₁ and R₂ are defined as R₃ and R₄ below or are joined to form a cycloalkyl, cycloalkenyl, aromatic or a heterocyclic ring containing an oxygen, nitrogen or sulfur atom or an alkoxy, amino, carboxyl, halo, hydroxyl, keto or a thiocarboxyl-substituted derivative thereof;

R₃ and R₄ are independently selected from (A) hydrogen, alkyl, cycloalkyl, alkenyl, cycloalkenyl, aryl, a heterocyclic ring containing an oxygen, nitrogen or sulfur atom, alkoxy, amino, carboxyl, halo, hydroxyl, keto or a thiocarboxyl and (B) substituted derivatives of the alkyl, cycloalkyl, alkenyl, cycloalkenyl, aryl and the heterocyclic ring wherein the substitutions are alkyl, cycloalkyl, alkenyl, cycloalkenyl, aryl, alkoxy, amino, carboxyl, halo, hydroxyl, keto or a thiocarboxyl;

a is 0 to 16;

W may be a single bond, oxygen, NR₅, or (CR₆R₇)ₘ, wherein R₅ is hydrogen, alkyl, cycloalkyl, alkenyl, cycloalkenyl, aryl or a heterocyclic ring containing an oxygen, nitrogen or sulfur atom or a substituted derivative of alkyl, cycloalkyl, alkenyl, cycloalkenyl or aryl groups wherein the substitutions are alkyl, cycloalkyl, alkenyl, cycloalkenyl, aryl, alkoxy, amino, carboxyl, halo, hydroxyl, keto, or a thiocarboxyl wherein R₆ and R₇ are defined as R₃ and R₄ above and m is an integer from 1 to 12. The above definition of R₅ includes, among other things, an aminoalkyl group.

The heterocyclic rings referred to in the above definitions may contain from 5 to 8 members, the alkyl or cycloalkyl groups from 1 to 18 atoms, the alkenyl or cycloalkenyl groups from 2 to 18 carbon atoms, and the aryl groups from 6 to 10 members.

In formula III, when R₁ and R₂ are hydrogen, R₃ and R₄ are carbonyl, R₅ is —CH═CH—CO₂H; a is equal to 0; and W is oxygen, the compound is iodopropynyl maleate,

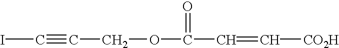

Other compounds include the mono-iodopropynyl esters of anhydrides such as succinic and phthalic as well as the following anhydrides: ethylenediamine tetraacetic dianhydride, 3,3-dimethylglutaric anhydride, S-acetylmercaptosuccinic anhydride, dichloromaleic anhydride, 2-dodecen-1-yl succinic anhydride and cis-5-norbomene-endo-2,3-dicarboxylic anhydride. Where hydrophilicity is desired, the sodium salts may be used because of their extremely high water solubility. Preferred carboxylic acid anhydrides include succinic, itaconic, phthalic, tetrachlorophthalic, and diglycolic anhydride. Such compounds are defined in U.S. Pat. No. 4,844,891 and 5,073,570.

Solvents

The preferred solvent used in formulations of the invention is butoxydiglycol, also known as 2-(2-butoxyethoxy)ethanol or diethylene glycol-n-butyl ether. Butoxydiglycol is the nomenclature used by the Cosmetic, Toiletry and Fragrance Association. Butoxydiglycol has the structure:

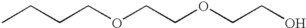

The inventors have now found that butoxydiglycol demonstrates synergistic antimicrobial properties when used in combination with halopropynyl compounds. Thus, the formulations containing a halopropynyl and butoxydiglycol demonstrate antimicrobial properties which are greater than would be expected from the addition of the known antifungal properties of halopropynyl and butoxydiglycol alone.

Formulations containing fungicidal halopropynyl compounds and butoxydiglycol also unexpectedly demonstrate a broad spectrum antimicrobial property, including bactericidal and fungicidal activity.

Some additional solvents which may also be present include water and other hydroxyl solvents. Hydroxyl solvents include mono-, di- and polyhydroxyl alcohols. For example, monohydroxyl alcohols having from about 1 to 7 carbon atoms, most preferably ethanol and propanol, may be used. Dihydroxyl alcohols (e.g., glycols) such as C₂ to C₈ diols, may also be used. Aside from butoxydiglycol, other glycols, such as C₂ to C₈ diols are advantageous. Other compounds which can be used include dipropylene glycol, glycerin, diglycerin, PPG-9, PPG-2-buteth-2, butoxypropanol, PPG-2 butyl ether, glycereth-7, isopentyldiol, myristyl myristate, phenoxy ethanol, and benzyl alcohol.

In the liquid preservative formulation embodiment of the invention comprising (a) a halopropynyl compound, (b) an isothiazolone derivative, and (c) an alkanol substituted dialkylhydantoin, the solvent may be any hydroxyl solvent. A preferred hydroxyl solvent is a butoxydiglycol solvent.

Isothiazolones

A second antifungal or antibacterial active component of the preservative formulation is one or more antimicrobial isothiazolone derivatives, such as 3-isothiazolones having formula IV:

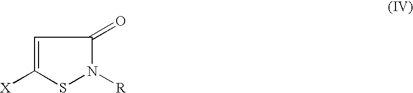

wherein X is hydrogen or halogen, preferably chlorine, and R is an alkyl chain of from 1 to 22 carbon atoms. Preferred isothiazolone derivatives include 5-chloro-2-methyl-4-isothiazolin-3-one (CMI) and 2-methyl-4-isothiazolin-3-one (MI), and mixtures thereof (e.g., CMI/MI). Other 3-isothiazolones can be used in the invention, including 4-chloro-2-methyl-4-isothiazolin-3-one, dichloroisothiazolones such as 4,5-dichloro-2-methyl-4-isothiazolin-3-one, bromoisothiazolones such as 5-bromo-2-methyl-4-isothiazolin-3-one, n-octylisothiazolones such as 2-n-octyl-4-isothiazolin-3-one, and benzisothiazolone.

Formaldehyde Donors

A third active component of the stabilized preservative formulation is a formaldehyde donor, such as a hydantoin, e.g., N,N″-methylene-bis[N′-(hydroxymethyl)-2,5-dioxo-4-imidazolidinyl]urea, N′-(hydroxymethyl)-N-(1,3-dihydroxymethyl-2,5-dioxo-4-imidazolidinyl]-N′-(hydroxymethyl)urea, and Quatemium-15. Preferred compounds are alkanol substituted dialkyl hydantoins having formula V:

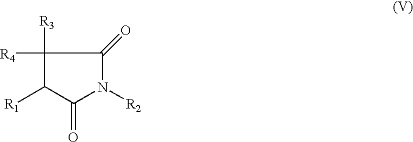

wherein R₁ and R₂ are each independently hydrogen or (CH₂)OH, with the proviso that both R₁ and R₂ cannot be hydrogen, and R₃ and R₄ are each independently hydrogen, a methyl group, an ethyl group, a propyl group, or an aryl group.

Alkanol-substituted dimethylhydantoin compounds are preferred formaldehyde donors. A preferred formaldehyde donor of formula (V) is dimethylol dimethyl hydantoin:

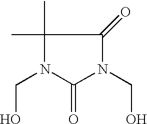

Alkanol-substituted dimethylhydantoin compounds are those described in U.S. Pat. Nos. 3,987,184 and 4,172,140. These are condensation products of 5,5-dimethylhydantoin with one or more moles of formaldehyde (e.g., 1 ,3-dimethylol-5,5-dimethylhydantoin, 1-methylol-5,5-dimethylhydantoin, or 3-methylol-5,5-dimethylhydantoin and 1-methylol-3-methyloloxymethylene-5,5-dimethylhydantoin, and mixtures thereof). Mixtures of alkanol-substituted DMH compounds can also be used. Other formaldehyde donors include n-hydroxymethyl-ureas such as imidazolinyl urea and diazolidinyl urea, diaminomethanes, 1,3-oxazolidines, quaternary hexaminium salts such as Quaternium 15, C-methylols, such as Bronopol, 2-bromo-2-nitro-propan-1-ol, and O-hydroxymethyl compounds and formals.

Stabilizers

The formulations of the invention also optionally comprise a stabilizer. Suitable stabilizers which may be used in the formulations including hydantoins, ureas and derivatives thereof. The hydantoins are represented by formula V:

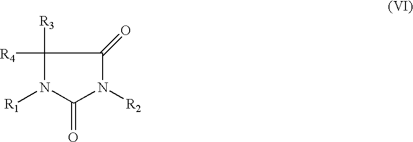

where R₁ to R₄ are independently selected from H, and a C₁ to C₂₂ alkyl group.

The N,N″-Methylenebis[N′-2,5-dioxo-4-imidazolidinyl]urea and its derivatives are represented by formula VII:

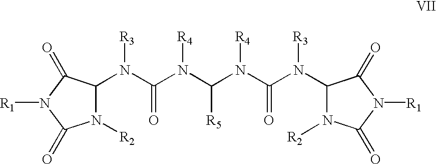

where R₁ to R₅ are independently selected from H or C₁ to C₂₂.

The 2,5-Dioxo-4-imidazolidinyl urea (5-ureidohydantoin) and its derivatives are represented by formula VIII:

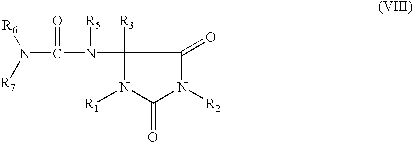

where R₁ to R₇ are independently selected from H, CH₃, C₂H₅ or C₃H₇.

Urea and its derivatives are represented by formula IX:

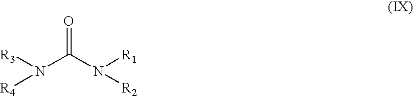

where R₁ to R₄ are independently selected from H or C₁ to C₁₂. Where all the R groups are H, the compound is urea.

Preferably, the stabilizer is 5,5-dimethylhydantoin or methylethylhydantoin (MEH).

Stabilizers are preferred in compositions of the invention comprising isothiazolone derivatives.

Formulations

The preservative concentrates of the invention can be readily prepared in accordance with procedures well known to those skilled in the art, simply by mixing the various components and adjusting the pH using any organic or mineral acid (e.g., hydrochloric acid and acetic acid) suitable for the user's purpose. The manner in which the components are mixed can be modified to suit the needs of the formulator, as discussed below, without departing from the spirit of the invention.

For example, in one method of forming the compositions of the invention, a halopropynl compound is first dissolved in a butoxydiglycol solvent, and the composition is then mixed until the solution becomes clear. Subsequently, other components of the formulation (for example, an isothiazolone derivative; a hydantoin formaldehyde donor, such as an alkanoldimethylhydantoin; and a stabilizer) can be added. Any water-based additive can be added to the halopropynyl-butoxydiglycol solution.

Because the halopropynyl compound dissolves easily in butoxydiglycol, the preparation of the composition of the invention does not require any heating steps, and the dissolution can occur at room temperature. Prior art methods involving solvents such as propylene glycol required a heating step to dissolve the halopropynyl compound.

The concentration of the active compounds in the use depends on the nature of the microorganisms to be combated and the composition of the final product to be preserved. For example, the optimum amount of preservative to use for preserving an aqueous composition can be determined by means of screening tests known in the art.

Typically, the components of the composition of the invention are added to personal care, household, and industrial products in amounts such that the final concentration of components remain in the following amounts: (1) for a formaldehyde donor (preferably an alkanoldimethylhydantoin) about 10 to about 800 ppm, preferably between about 10 and about 500 ppm; (2) for a halopropynyl from about 1 to about 100 ppm, preferably from about 2 to about 50 ppm; and (3) for an isothiazolone derivative from about 0.01 to about 5.0 ppm, preferably from about 0.01 to about 2 ppm. The reminder of the composition may be butoxydiglycol, and/or optionally other solvents.

The preservative of the invention is useful for combating microorganisms and, in particular, for the preservation of household, industrial and personal care products, such as cosmetics, lotions, creams, deodorants, shampoos, and soaps. Personal care products include any product that is applied to or contacted with the body of humans or animals in normal use. The following is a list of products that can benefit from incorporation of the preservative system of the invention but is not intended to limit the invention thereto: adhesives, including starch, paper and cardboard, textiles, leather, wood and wood products, paints and articles made of plastic, all purpose liquid cleaners, liquid dishwashing detergent, automotive cleaner, surfactant solutions, household polishes, automotive wax, air freshener, carpet shampoo, pre-spotter, liquid laundry products, pesticide for growing crops, non-food fungicide, non-food herbicide, non-food insecticide, non-food repellent, non-food biopesticide, anti-tarnish products, pre-moistened sponges, pre-moistened mops, clay slurries, coatings, polymer emulsion, natural latex, mineral slurries, pigment slurries, water-based building compounds, caulk, sealer, metal working fluids, metal cleaning fluids, hydraulic fluids, electrodeposition fluids, industrial process water, air washer systems, oil field injection water, liquid hydrocarbon fuels, industrial recirculating cooling water, lubricants, and other materials which can be attacked or decomposed by microorganisms.

Microorganisms which effect contamination or degradation of products include bacteria, fungi, yeasts, algae, and slime. Microorganisms of the following genera are examples: Alternaria, such as Alternaria tenuis, Aspergillus, such as Aspergillus niger, Chaetomium, such as Chaetomium globosum, Candida, such as Candida albicans, Lentinus, such as Lentinus tigrinus, Penicillium, such as Penicillium glaucum, Trichophyton, such as Trichophyton mentagrophytes, Aureobasidium, such as Aureobasidium pullulans, Enterobacter, such as Enterobacter gergoviae, Trichoderma, such as Trichoderma viride, Eseherichia, such as Escherichia coli, Pseudomonas, such as Pseudomonas aeruginosa and Burkholderia cepacia, and Staphylococcus, such as Staphylococcus aureus and Staphylococcus epidermidis.

Preservative formulations of the invention can also be used directly as they are manufactured without dilution, or in any other manner traditionally used in manufacturing, such as by metering.

Exemplary Embodiments of the Invention

The following Examples are provided to further teach the invention and are not intended to limit the scope thereof. All parts and percentages are given by weight unless otherwise indicated.

### EXAMPLE 1

### Solubility Data

Several propynyl compounds (including halopropynyl compounds) were tested for solubility in butoxydiglycol. The compounds used in Example 1 are identified below in Table 1.

TABLE 1
Compounds

| | Chemical name | |
|---|---|---|
| Compound | (IUPAC) | Chemical structure |
| L58 | 1N,3N-Diiodopropyn-2-yl- 5-chlorouracil | 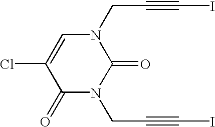 |
| L64 | 1-(2,4-dichlorophenyl)-2- propyn-1-ol | 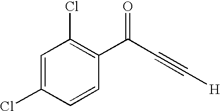 |
| L74 | 3-iodo-1-(4- trifluoromethylphenyl)-2- propyn-1-one | 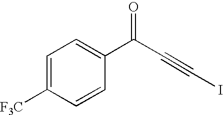 |
| L90 | 2-(3-iodo-2-propyn-1-ol-yl) thiophene | 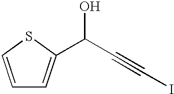 |
| L100 | 5-Chloro-2-(1-hydroxy-3- iodo-2-propyl)thiophene | 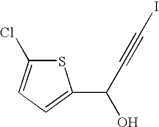 |
| L103 | 2-(1-imidazolyl)-1-(4- methylphenyl)ethyl iodopropargyl ether | 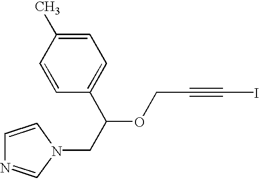 |
| L106 | 1-(4-cyanophenyl)-2- propyn-1-one | 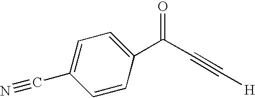 |
| L111 | Iodopropynyloxypropionic Acid | 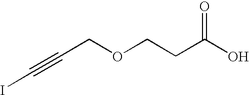 |

The results of the solubility testing is shown below in Table 2. A “+” indicates that the propynyl compound is soluble, whereas a “−” indicates that the propynyl compound is insoluble. An “x” indicates that the solubility test was not conducted for that combination of propynyl compound and solvent.

L58, L74, L90, L100, L103 and L111 are halopropynyl compounds.

TABLE 2
Solubility Data for Propynyl Compounds

| | COMPOUND | | | | | |
|---|---|---|---|---|---|---|
| SOLVENT | L103 | L90 | L106 | L58 | L74 | L64 |
| Butanediol Anhydrous | − | + | + | − | + | + |
| Sorbitol | − | − | − | x | x | x |
| Butoxydiglycol | + | + | + | + | + | + |

Table 2 demonstrates that the propynyl compounds are soluble in butoxydiglycol.

### EXAMPLE 2

### Testing of Antifungal and Antibacterial Properties of Solutions of Propynyl Compounds

Each of the samples A to E is a protein shampoo comprising a propynyl compound. The samples were tested for antibacterial and antifungal properties by testing for inhibition of a mixed bacteria, comprising E. coli (ATCC 8739), P. aeruginosa (ATCC 9027), and S. aureus (ATCC 6538), and inhibition of a mixed fungi, comprising A. niger (ATCC 16404) and C. albicans (ATCC 10231). The results are depicted below, in Table 3.

The samples “GPL” and “NP” are controls. “GPL” is 0. 1% Glydantg Plus, a liquid antimicrobial preservative available from Lonza Inc., Fair Lawn, N.J., containing a dimethyol dimethyl hydantoin formaldehyde donor. Glydant® Plus is used in personal care formulations in cosmetics and personal care products. “NP” is a protein shampoo which does not contain any preservatives.

In Table 3, samples A and E consist of an iodopropynyl compound in a butoxydiglycol solvent. Samples C and D consist of an iodopropynyl compound in a butylene glycol solvent, and Sample B consists of a propynyl compound in a butylene glycol solvent.

Table 3
Screening of Halopropynyl Solutions for Antifungal
and Antibacterial Properties

| | | DAY 0 | | DAY 14 | | DAY 28 | |
|---|---|---|---|---|---|---|---|
| | Conc. | Bacteria | Fungi | Bacteria | Fungi | Bacteria | Fungi |
| SAMPLE | (ppm) | (cfu/ml) | (cfu/ml) | (cfu/ml) | (cfu/ml) | (cfu/ml) | (cfu/ml) |
| A (L58) | 500 | 8.00 × 10⁶ | 1.00 × 10⁵ | <10 | <10 | <10 | <10 |
| B (L64) | 500 | 8.00 × 10⁶ | 1.00 × 10⁵ | >3.0 × 10³ | <10 | >10³ | >10³ |
| C (L74) | 500 | 8.00 × 10⁶ | 1.00 × 10⁵ | >3.0 × 10³ | <10 | >10³ | >10³ |
| D (L90) | 500 | 7.00 × 10⁶ | 1.00 × 10⁵ | >3.0 × 10³ | <10 | >10³ | >10³ |
| E (L103) | 500 | 7.00 × 10⁶ | 1.00 × 10⁵ | <10 | 500 | <10 | 400 |
| GPL | 1000 | 9.00 × 10⁶ | 2.00 × 10⁵ | <10 | <10 | <10 | <10 |
| NP | — | 9.00 × 10⁶ | 2.00 × 10⁵ | 9.00 × 10⁶ | 1.00 × 10⁵ | 9.00 × 10⁶ | 1.00 × 10⁵ |

“Cfu/ml” represents colony forming units per milliliter.

“Cfu/ml” represents colony forming units per milliliter.

The results in Table 3 show that the halopropynyl compounds dissolved in butoxydiglycol have unexpected antibacterial properties.

### EXAMPLE 3

### Testing of Antifungal and Antibacterial Properties of Halopropynyl Compounds in Protein Shampoo Formulations

Samples of a standard protein shampoo (pH-7.0) were formed. The shampoo contained the following preservative-free ingredients, w/w %

| | |
|---|---|
| Sodium lauryl ether | 35.0% |
| triethanolamine | 25.0% |
| lauryl sulfate | |
| cocomide DEA | 3.0% |
| anhydrous protein | 1.0% |
| sterile DI water | 36.0% |
| 10% citric acid | 0.3% |

Samples A, F and H contained active preservative iodopropynyl agents in a solvent. Samples A and H contained butoxydiglycol as the solvent. Samples F and G (containing a propynyl compound rather than a halopropynyl compound) contained butylene glycol as the solvent. Results of the antifungal and antibacterial testing are depicted in Table 4 below.

TABLE 4
Antifungal and Antibacterial Screening of Propynyl
Compositions in Protein Shampoo Formulations

| | | DAY 0 | | DAY 14 | | DAY 28 | |
|---|---|---|---|---|---|---|---|
| | Conc. | Bacteria | Fungi | Bacteria | Fungi | Bacteria | Fungi |
| SAMPLE | (ppm) | (cfu/ml) | (cfu/ml) | (cfu/ml) | (cfu/ml) | (cfu/ml) | (cfu/ml) |
| A | 500 | 9.00 × 10⁶ | 1.00 × 10⁵ | <10 | <10 | <10 | <10 |
| (L58) | | | | | | | |
| F | 500 | 8.00 × 10⁶ | 1.00 × 10⁵ | 2.00 × 10¹ | <10 | 200 | <10 |
| (L100) | | | | | | | |
| G | 500 | 8.00 × 10⁶ | 1.00 × 10⁵ | >1.0 × 10⁴ | >1.0 × 10³ | <10 | 100 |
| (L106) | | | | | | | |
| H | 500 | 8.00 × 10⁶ | 8.00 × 10⁶ | <10 | <10 | <10 | <10 |
| (L111-01) | | | | | | | |
| GPL | 1000 | 9.00 × 10⁶ | 2.00 × 10⁵ | <10 | <10 | <10 | <10 |
| NP | — | 9.00 × 10⁶ | 2.00 × 10⁵ | 9.00 × 10⁶ | 1.00 × 10⁵ | 9.00 × 10⁶ | 1.00 × 10⁴ |

These results demonstrate that halopropynl compounds in a butoxydiglycol solvent have strong antibacterial and antifungal efficacy. The data indicates that the combination of a halopropynyl and a butoxydiglycol solvent may have commercial utility as an antibacterial and antifungal, broad spectrum preservative.

### Example 4

### Testing of Minimum Inhibitory Concentration

The following example demonstrates the synergistic properties of IPBC and butoxydiglycol solvent against the bacteria Burkholderia cepacia. Sample protein shampoos I, J and K were formed. Sample I contained only IPBC. Sample J contained only butoxydiglycol. Sample K contained both IPBC and butoxydiglycol.

The results show that either 1,250 ppm of IPBC or 12,500 ppm of butoxydiglycol is required to completely inhibit growth of B. cepacia (samples I,J). However, when IBPC and butoxydiglycol are combined in a single formulation, only 312 ppm of IPBC and 3,250 ppm of butoxydiglycol inhibit bacterial growth.

TABLE 5
Synergy between IPBC and Butoxydiglycol Against Burkholderia Cepacia

ACTIVE INGREDIENT

| Sample | IPBC | Butoxydiglycol | MIC, ppm active |
|---|---|---|---|
| I | + | − | 1,250 |
| J | − | + | 12,500 |
| K | + | + | 312 (IPBC)/ |
| | | | 3,250 (butoxydiglycol) |

MIC is the “minimum inhibitory concentration,” or the minimum concentration which completely inhibits microbial growth. A “+” indicates that the active is present in the sample, whereas a “−” indicates that the active is not present in the sample.

The data in Table 5 demonstrates that the presence of a halopropynyl such as IPBC and butoxydiglycol solvent has synergistic properties, i.e., the presence of the butoxydiglycol increases the antibacterial efficacy of the halopropynyl compound.

The data in Table 5 also demonstrates the broader efficacy demonstrated by formulations containing a fungicidal halopropynyl compound and butoxydiglycol. The formulations of the invention unexpectedly demonstrate antibacterial properties, in addition to the known fungicidal properties of the halopropynyl compound.

Synergism for the IPBC/butoxydiglycol studies in Table 5 was calculated by the method described in C. E. Kull et al., “Mixtures of Quaternary Ammonium Compounds and Long-Chain Fatty Acids as Antifungal Agents”, Applied Microbiology, 4:538-541(1961). The Kull method determines the quantity of each component in a mixture which is required to reach a given microbiological endpoint (e.g., MIC), and compares that amount with the quantity of the pure component necessary to reach the same endpoint. According to this method, a synergism index or value Q_{A}/Q_{B}+Qₐ/Q_{b} is determined, wherein:

Qₐ the concentration of IPBC, acting alone, which results in MIC:

Q_{b} is the concentration of butoxydiglycol, acting alone, which results in MIC;

Q_{A} is the concentration of IPBC in mixture with butoxydiglycol, which results in MIC; and

Q_{B} is the concentration of butoxydiglycol in mixture with IPBC, which results in MIC.

When the value of (Q_{A}/Qₐ+Q_{B}/Q_{b}) is less than 1.0, the mixture is synergistic. Values for (Q_{A}/Qₐ+Q_{B}/Q_{b}) of 1.0 and greater than 1.0 represent an additive effect and an antagonist effect, respectively.

The results calculated from the experimental results in Table 5 are shown in Table 6 below.

TABLE 6
Synergism Index for IPBC and Butoxydiglycol Combinations

| | Concentration (ppm) | | | | Synergism Index |
|---|---|---|---|---|---|
| Parameter | Q_{A} | Q_{B} | Q_{C} | Q_{D} | Qₐ/Q_{A} + Q_{b} /Q_{B} |
| MIC | 1,250 | 12,500 | 312 | 3,250 | 0.51 |

The synergism index value of 0.51 indicates a synergistic relationship between the halopropynyl compound IPBC and butoxydiglycol.

### EXAMPLE 5

### Testing of IPBC in Antibacterial Properties of Shampoo Formulations

The test formulations L and M were prepared by mixing 14% isothiazolone (CMI/MI 2.8:1) with Glydant® 2000 (a dimethylol dimethyl hydantoin sold by Lonza Inc., Fair Lawn, N.J.), with or without IPBC in protein shampoo. IPBC was preliminary dissolved in butylene glycol at 50° C. and subjected to intense stirring for 30 minutes, and then incorporated in protein shampoo. Minimum Inhibitory Concentrations against Burkholderia cepacia ATCC 25416 are shown in Table 7.

TABLE 7
Evaluation of Preservative Formulations in Protein Shampoo

| | Active ingredient | | | |
|---|---|---|---|---|
| | | Glydant ®, | | |
| Sample | IPBC, ppm | % product | CMI/MI, ppm | MIC |
| L | − | + | + | 0.1% Glydant ® |
| | | | | 0.55 ppm (CMI/ |
| | | | | MI) |
| M | + | + | + | 0.05% Glydant ® |
| | | | | 0.27 ppm (CMI/ |
| | | | | MI) |
| | | | | 156 ppm IPBC |

Four protein shampoo test formulations were prepared and tested in protein shampoo: one without the addition of preservative and three with varying amounts of IPBC (a halopropynyl), Glydant® 2000 (a DMDMH formaldehyde donor), CMI/MI (isothiazolone derivatives), and butoxydiglycol. The composition of tested formulations is shown in Table 8.

TABLE 8
Final Concentration of Active Ingredients Used in Test Formulations

| | Concentration in protein shampoo | | | |
|---|---|---|---|---|
| | | Glydant ®, | CMI/MI, | |
| Sample | IPBC, ppm | % product | ppm | Butoxydiglycol |
| N | — | — | — | — |
| O | 50 | 17.5 | 0.06 | 1000 |
| P | 100 | 17.5 | 0.06 | 2000 |
| Q | 50 | 35 | 0.12 | 1000 |
| R | 100 | 35 | 0.12 | 2000 |

The samples N, O, P, and Q and R were tested in a preservative Challenge Test against mixed bacteria comprising Pseudomonas aeruginosa ATCC 9027, Staphylococcus aureus ATCC 6538, and Escherichia coli ATCC 8739. The challenge test results are shown in Table 9.

TABLE 9
Challenge Test Results for Preservative Blend in Protein Shampoo

Efficacy cfu/ml

| Sample | Day 0 | Day 7 |
|---|---|---|
| N | 6.0 × 10⁶ | 8.0 × 10⁶ |
| O | 6.5 × 10⁶ | <10 |
| P | 6.0 × 10⁶ | <10 |
| Q | 7.0 × 10⁶ | <10 |
| R | 6.5 × 10⁶ | <10 |

Cfu/ml—colony forming units in 1 ml.

All patents, patent publications, and literature references cited in this specification are hereby incorporated by reference in their entirety.

Many variations of the present invention will suggest themselves to those skilled in the art in light of the above detailed description. Such obvious variations are within the full scope of the appended claims.

What is claimed is:

1. A liquid synergistic preservative formulation comprising a halopropynyl compound and butoxydiglycol solvent.

2. The preservative formulation of claim 1, wherein said halopropynyl compound is a compound of formula I:
YC≡C—CH₂X
wherein Y is a halogen, X is selected from the group consisting of O, N, S or C, wherein said O, N, S, or C is part of an organic functional group.

3. The preservative formulation of claim 1, wherein said halopropynyl compound is an iodopropynyl compound.

4. The preservative formulation of claim 2, wherein X is carbon, oxygen or nitrogen and is part of an ether, ester or carbamate group.

5. The preservative formulation of claim 2, wherein X is nitrogen and is part of an amine, amide or a carbamate group.

6. The preservative formulation of claim 3, wherein said iodopropynyl compound is a compound of formula II: 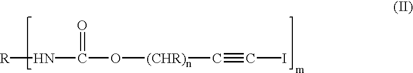
wherein:
R is selected from the group consisting of substituted and unsubstituted alkyl, aryl, and alkylaryl groups having from 1 to 20 carbon atoms; and
m and n are independently selected from 1, 2 or 3.

7. The preservative formulation of claim 3, wherein said iodopropynyl compound is a compound of formula III: 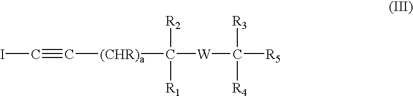
wherein:
R₁ and R₂ are defined as R₃ and R₄ below or are joined to form a cycloalkyl, cycloalkenyl, aromatic or a heterocyclic ring containing an oxygen, nitrogen or sulfur atom or an alkoxy, amino, carboxyl, halo, hydroxyl, keto or a thiocarboxyl-substituted derivative thereof;
R₃ and R₄ are independently selected from (A) hydrogen, alkyl, cycloalkyl, alkenyl, cycloalkenyl, aryl, a heterocyclic ring containing an oxygen, nitrogen or sulfur atom, alkoxy, amino, carboxyl, halo, hydroxyl, keto or a thiocarboxyl and (B) substituted derivatives of the alkyl, cycloalkyl, alkenyl, cycloalkenyl, aryl and the heterocyclic ring wherein the substitutions are alkyl, cycloalkyl, alkenyl, cycloalkenyl, aryl, alkoxy, amino, carboxyl, halo, hydroxyl, keto or a thiocarboxyl;
a is 0 to 16;and
W may be a single bond, oxygen, NR₅, or (CR₆R₇)ₘ, wherein R₅ is hydrogen, alkyl, cycloalkyl, alkenyl, cycloalkenyl, aryl or a heterocyclic ring containing an oxygen, nitrogen or sulfur atom or a substituted derivative of alkyl, cycloalkyl, alkenyl, cycloalkenyl or aryl groups wherein the substitutions are alkyl, cycloalkyl, alkenyl, cycloalkenyl, aryl, alkoxy, amino, carboxyl, halo, hydroxyl, keto, or a thiocarboxyl wherein R₆ and R₇ are defined as R₃ and R₄ above; and
m is an integer from 1 to 12.

8. The preservative formulation of claim 7, wherein said compound of formula III is iodopropynyl maleate.

9. A personal care product, household product or industrial product comprising an antimicrobial effective amount of a preservative formulation of claim 1.

10. A method for killing or inhibiting the growth of microbes in a composition susceptible to growth, comprising adding to said composition an antimicrobial effective amount of a preservative formulation of claim 1.

11. The preservative formulation of claim 1, further comprising an alkanol substituted dialkylhydantoin.

12. The preservative formulation of claim 11, wherein said alkanol substituted dialkyl hydantoin is a compound of formula V: 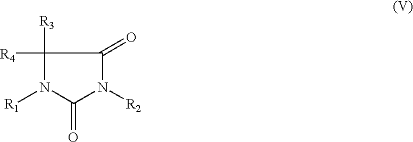
wherein R₁ and R₂ are each independently hydrogen or (CH₂)OH, with the proviso that both R₁ and R₂ cannot be hydrogen, and R₃ and R₄ are each independently methyl, ethyl, propyl, or aryl.

13. The preservative formulation of claim 11 wherein said alkanol substituted dialkylhydantoin is dimethylol dimethylhydantoin.

14. A personal care product, household product or industrial product comprising an antimicrobial effective amount of a preservative formulation of claim 11.

15. A method for killing or inhibiting the growth of microbes in a composition susceptible to growth, comprising adding to said composition an antimicrobial effective amount of a preservative formulation of claim 11.

16. A liquid preservative formulation, comprising
a) a halopropynyl compound;
b) an alkanol substituted dialkylhydantoin;
c) a hydroxyl solvent; and
d) an isothiazolone derivative.

17. The preservative formulation of claim 16, wherein said hydroxyl solvent is butoxydiglycol.

18. The preservative formulation of claim 16 wherein said isothiazol one derivative is a compound of formula IV: 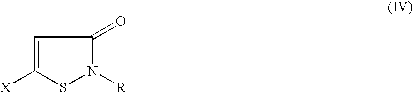
wherein X is hydrogen or halogen, and R is C₁₋₂₂ alkyl.

19. The preservative formulation of claim 16 wherein said isothiazolone derivative is selected from the group consisting of 5-chloro-2-methyl-4-isothiazolin-3-one and 2-methyl-4-isothiazolin-3-one.

20. The preservative formulation of claim 16 wherein said isothiazolone derivative is selected from the group consisting of 4-chloro-2-methyl-4-isothiazolin-3-one; 4,5-dichloro-2-methyl-4-isothiazolin-3-one; 5-bromo-2-methyl-4-isothiazolin-3-one; 2-n-octyl-4-isothiazolin-3-one; and benzisothiazolone.

21. The preservative formulation of claim 16, further comprising a stabilizer.

22. The preservative formulation of claim 21 wherein said stabilizer is selected from the group consisting of (a) a compound of formula VI: 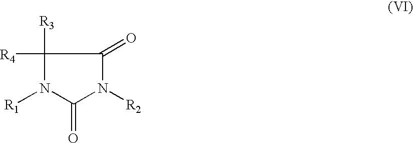
where R₁ to R₄ are independently selected from H and a C₁ to C₂₂ alkyl; or
(b) a compound of formula VII: 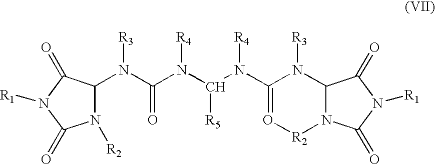
wherein R₁ to R₅ are independently selected from H or C₁ to C₂₂ alkyl; or
(c) a compound of formula VIII: 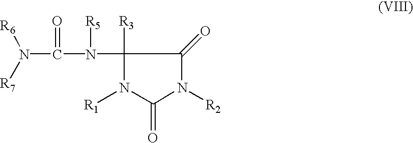
where R₁ to R₇ are independently selected from H, CH₃, C₂H₅ or C₃H₇; or
(d) a compound of formula IX: 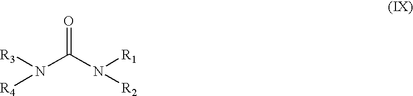
where R₁ to R₄ are independently selected from H or C₁ to C₂₂ alkyl.

23. The preservative formulation of claim 16 wherein said alkanol substituted dialkylhydantoin is

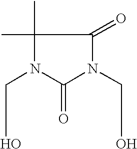

24. The preservative formulation of claim 21, wherein said stabilizer is 5,5-dimethylhydantoin or methylethylhydantoin.

25. A personal care product, household product, or industrial product comprising an antimicrobial effective amount of a preservative formulation of claim 16.

26. A method for killing or inhibiting the growth of microbes in a composition susceptible to growth, comprising adding to said composition an antimicrobial effective amount of a preservative formulation of claim 16.

27. A method of making a liquid preservative formulation, comprising dissolving a halopropynyl compound in a butoxydiglycol, and optionally adding a water-based additive.

28. The method of claim 27, wherein said halopropynyl compound is an antimicrobial iodopropynyl compound.

29. The method of claim 27, wherein said water-based additive is selected from the group consisting of an isothiazolone derivative, an alkanol substituted dialkylhydantoin, and a stabilizer.

30. The method of claim 27, wherein said step of dissolving occurs at room temperature.
